(19) United States
(12) Patent Application Publication
(10) Pub. No.: US 2026/0179871 A1
(43) Pub. Date: Jun. 25, 2026

(54) METHOD FOR REDUCING THE AMOUNT OF GAS BUBBLES ON THE SURFACE OF A GLASS TUBE AND APPARATUS THEREFORE

(71) Applicant: Schott AG, Mainz (DE)

(72) Inventors: Rainer Eichholz, Mitterteich (DE); Jens Ahrens, Mitterteich (DE); Thomas Pfeiffer, Ingelheim (DE)

(73) Assignee: Schott AG, Mainz (DE)

(21) Appl. No.: 19/426,421

(22) Filed: Dec. 19, 2025

(30) Foreign Application Priority Data
Dec. 19, 2024 (EP) 24221608.3

(51) Int. Cl. H01J 1/94; C03B 5/16; C03B 5/167; C03B 17/04; C03C 3/091; H01B 1/02

(52) U.S. Cl. CPC H01J 1/94; C03B 5/163; C03B 5/1677; C03B 17/04; C03C 3/091; H01B 1/02

(57) ABSTRACT

A glass tube forming apparatus includes a tube forming body configured to receive a flow of molten glass from a glass melt, the molten glass being withdrawn from the tube forming body in the form of a glass tube, the tube forming body being covered at least partly with a metallic layer; and at least one metallic electrode mounted in the glass melt in spaced relation to the tube forming body. The tube forming body is connected electrically with the at least one electrode.

### CROSS REFERENCE TO RELATED APPLICATIONS

This application claims priority to European Patent Application No. 24221608.3 filed on Dec. 19, 2024, which is incorporated in its entirety herein by reference.

### BACKGROUND OF THE INVENTION

### 1. Field of the Invention

The present invention refers to a glass tube forming apparatus. Furthermore, the present invention refers to a method for reducing the amount of gas bubbles on the contact surface of a glass tube, a glass tube produced by the method as well as to the use of such a glass tube in the pharmaceutical sector.

### 2. Description of the Related Art

Methods for producing glass tubes as well as glass tube forming apparatuses have been known for centuries. Nevertheless, there are still a number of fundamental problems today, arising from the nature of the glasses themselves and from the associated production methods. One such problem is, for example, that the glass melts always contain a certain amount of water which might be present in dissolved molecular form, but also as OH groups bound to individual melt components. Due to the very high temperatures needed for melting the melt components and processing the glass melt, the water present in the glass melt might split into a more or less large percentage of hydrogen and oxygen by the following redox reaction:

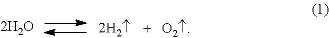

comprising the following sub-steps:

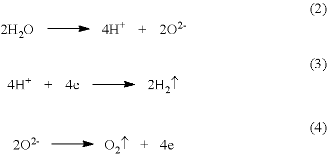

Often the glass tube forming apparatuses are permeable for hydrogen, so that the hydrogen can diffuse out of the glass melt. Due to the withdrawal of H₂, the equilibrium of reaction (1) is shifted to the right-hand side of the reaction equation. This results in a local depletion of hydrogen and an increase of oxygen O₂ in the melt. If the produced oxygen is no longer chemically bound and the oxygen concentration in the glass melt exceeds a critical value, the so-called saturation concentration, small oxygen-containing bubbles can occur in the glass melt. If these gas bubbles enter the product, the quality of the generated glass products, especially for the use in the pharmaceutical sector, is significantly affected and the yield of a bubble-free glass will be drastically reduced. It is especially problematic if small gas bubbles occur on the surface of the glass tubes. These gas bubbles lead to elongated bubbles during the hot forming and drawing process also called “air lines” or sometimes “seeds”. More precisely, these gas bubbles might result in closed air lines and, in case the bubbles are very close to the surface, they open during the hot forming and drawing process, resulting in so-called “open air lines” as glass defects.

“Open air lines” might affect the volume of the obtained, vials, cartridges and syringes that are produced from the glass tubes. “Closed air lines” often comprise only very thin glass membranes, that might crush due to force of a liquid, resulting in glass glimmers within that liquid.

Even if the underlying reaction (1) for the mechanism of water decomposition and hence local formation of gas bubbles in the melt initially appears very simple, in practice it is difficult to be controlled or described, since the decomposition of water in a glass melt is influenced by a great number of factors, in particular by the water content and solubility of water in the melt; type of the one or more metal(s) with which the melt comes into contact; thickness of the metal-comprising component; temperature and dwell time of the glass; redox state of the glass; type and content of the redox-active components (e.g. refining agents) in the glass melt or composition of the atmosphere.

Furthermore, even if glass is a non-conductive material in the solid state, it is an electrically conductive electrolyte in melted form and can transmit voltage potentials that are present in the melt. However, especially direct current (DC) voltage potentials can be critical for the formation of gas bubbles in the melt due to a shift of the pO₂. These direct current voltage potentials can occur in the system, for example, due to electrodes in the system, especially in the melting tank, or due to battery effects.

In order to avoid the occurrence of gas bubbles in the end product, several measures are used in the prior art. For example, particularly low-water raw materials can be used, or redox-active components can be added to the glass melt. Such a glass composition with redox-active components is, for example, known from EP0464501. Also, the temperature of the glass melt or the dwell time on the noble metal-comprising component may be adjusted so that no bubbles will arise. Furthermore, an electric current can be used to maintain an electrical negative potential difference in the glass melt compared to components made of metal subsequent to the melting tank as described in DE19955827.

However, there are some limits to each of these measures, for example when a high-viscosity glass is melted, which due to the high melt viscosity will have a dwell time that cannot be reduced to below a critical dwell time. The addition of redox-active substances may lead to the formation of detrimental components in the melt. If bubble formation occurs at the outlet of the melting unit, it is moreover not readily possible to adjust a temperature which is known to cause no decomposition of the water in the melt, since certain requirements in terms of melt viscosity and hence temperature have to be met for the hot forming of glass. In such cases, measures have to be taken which reduce or even completely prevent the mechanism of water decomposition and, therefore, the formation of gas bubbles.

Therefore, although there are a number of approaches for reducing the mechanism of water decomposition and/or hydrogen removal, these methods still have a number of drawbacks as mentioned above. What is lacking, therefore, is a simple and cost-efficient apparatus and method for producing glass products from a melt, in which bubble formation is reduced or even completely suppressed to produce glass tubes with a reduced amount of gas bubbles on the contact surface of a glass tube and, therefore, with a reduced amount of an aggregated air line length on the surface on the inside of the glass tube. Furthermore, the apparatus and the method should be designed in such a way that gas bubbles at the drawing tool are reduced or eliminated. The process should be easy to handle. In particular, it is desirable that no additional chemicals such as heavy metals are used in the glass melt. Furthermore, the time for drawing and further processing of the tubes should not be greatly affected. It is also desirable that the method is designed in such a way that existing apparatuses can be used to a large extent and only require a small amount of conversion in order to save costs. Of course, the equipment used must be simple and safe to operate.

### SUMMARY OF THE INVENTION

In some embodiments provided according to the present invention, a glass tube forming apparatus includes a tube forming body configured to receive a flow of molten glass from a glass melt, the molten glass being withdrawn from the tube forming body in the form of a glass tube and the tube forming body is covered at least partly with a metallic layer; and at least one metallic electrode mounted in the glass melt in spaced relation to the tube forming body. The tube forming body is connected electrically with the at least one electrode.

In some embodiments provided according to the present invention, a method for reducing an amount of gas bubbles on a contact surface of a glass tube includes: providing a tube forming body configured to receive a flow of molten glass from a glass melt, the tube forming body being covered at least partly with a metallic layer; providing at least one metallic electrode mounted in the glass melt in spaced relation to the tube forming body; providing an electrical connection between the tube forming body and the at least one electrode; generating a potential drop between the tube forming body and the at least one electrode to cause a direct current; and withdrawing the molten glass from the tube forming body in the form of a glass tube as the direct current flows between the tube forming body and the at least one electrode.

In some embodiments provided according to the present invention, a glass tube has an aggregated air line length of less than 0.10 m per 1.0 m tube length on a contact surface of the glass tube. The aggregated air line length is defined as a sum of lengths of closed air lines having a length>15 mm and open air lines having a length>2 mm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic of an exemplary embodiment of a glass tube forming apparatus provided according to the present invention;

FIG. 2 is a schematic of an exemplary embodiment of a glass tube forming apparatus provided according to the present invention comprising more than one tube forming body;

FIG. 3 is a schematic of an exemplary embodiment of a glass tube forming apparatus provided according to the present invention comprising more than one electrode.

FIG. 4 is a schematic of an exemplary embodiment of a glass tube forming apparatus provided according to the present invention comprising additional electronic components; and

FIG. 5 is an exemplary schematic of the electric circuit.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

According to one aspect of the present invention, a glass tube forming apparatus is provided, comprising:
a) a tube forming body configured to receive a flow of molten glass, wherein the molten glass is withdrawn from the forming body in form of a glass tube, and
b) at least one metallic electrode, wherein the at least one metallic electrode is mounted in the glass melt in spaced relation to the tube forming body,
wherein the tube forming body is covered at least partly with a metallic layer, and wherein the tube forming body is connected electrical with the at least one electrode.

According to another aspect of the present invention, a method for reducing the amount of gas bubbles on the contact surface of a glass tube is provided, the method comprising the steps of
i) providing a tube forming body, configured to receive a flow of molten glass, wherein the tube forming body is covered at least partly with a metallic layer, and
ii) providing at least one metallic electrode, wherein the at least one metallic electrode is mounted in the glass melt in spaced relation to the tube forming body,
iii) providing an electrical connection between the tube forming body and the at least one electrode,
iv) generating a potential drop between the tube forming body and the at least one electrode to cause a direct current and
v) withdrawing the molten glass from the tube forming body in form of a glass tube during the direct current flows between the tube forming body and the at least one electrode.

According to another aspect of the present invention, a glass tube produced by the method is provided. According to another embodiment, the glass tube has an aggregated air line length of less than 0.10 m per 1.0 m tube length on the contact surface of the glass tube, wherein the aggregated air line length is defined as the sum of the lengths of closed air lines having a length>15 mm and open air lines having a length>2 mm.

According to another embodiment of the present invention, the glass tube is used as an intermediate product for the production of pharmaceutical containers, optionally for the production of ampoules, vials, syringes and/or cartridges.

The inventors have surprisingly found that with the apparatus and the method provided according to the present invention, it is possible to reduce or even avoid the gas bubble formation, especially the formation of oxygen bubbles, on the surface of a glass tube that has direct contact with the metal on the tube forming body when the glass tube is produced. This may be especially advantageous since, due to the reduced oxygen bubble formation on the surface of a glass tube, it is possible to produce glass tubes with a reduced amount of aggregated air line length, especially with an aggregated air line length of less than 0.10 m per 1.0 m tube length on the contact surface of the glass tube. Due to the reduced amount of gas bubbles, the yield of the glass tubes can be improved. Furthermore, by the apparatus and the method provided according to the present invention, it is possible to improve the quality of the generated glass tubes and therefore of the glass products obtained from the glass tubes, especially for the use in the pharmaceutical sector.

The inventors have found that the above method is easy to handle, economic, since existing apparatuses can be used to a large extent and only require a small amount of conversion, and environmentally friendly, since no additional chemicals are used in the glass melt. Furthermore, the time for drawing and further processing of the tubes is not affected.

According to some embodiments, the metal of the metallic layer on the tube forming body and/or the metallic electrode are selected from the group consisting of molybdenum, tungsten, tantalum, tin oxide, platinum, rhodium, iridium, and alloys thereof, high melting refractory metals, oxides thereof and alloys thereof, oxide dispersion-strengthened metal compounds and alloys thereof, and heat-resistant steel, and optionally are selected from the group consisting of platinum, molybdenum, tungsten and alloys thereof and oxide dispersion-strengthened metal compounds and alloys thereof.

According to some embodiments, the metal of the metallic layer on the tube forming body and the metallic electrode are different metals, optionally are selected from the group consisting of platinum, molybdenum, tungsten and alloys thereof as well as oxide dispersion-strengthened alloys and compounds thereof and optionally the metal of the metallic layer on the tube forming body is platinum or platinum alloy or an oxide dispersion-strengthened platinum alloy and the metal of the metallic electrode is molybdenum or tungsten or an oxide dispersion-strengthened molybdenum or tungsten alloy.

According to some embodiments, the at least one metallic electrode is mounted in the melting vessel and/or the fining vessel and/or working tank and/or distributor, and optionally is mounted in the melting vessel.

According to some embodiments, the glass tube forming apparatus further comprises an electronic voltage filter, that is located in series in the electrical connection between the tube forming body and the at least one electrode, and optionally the electronic voltage filter comprises a resistor, a capacitor and/or an inductance.

According to some embodiments, the glass tube forming apparatus further comprises an electronic voltage adjustment or electronic voltage control, that is located in series in the electrical connection between the tube forming body and the at least one electrode, and optionally the electronic voltage control is a variable resistor and optionally selected from the group consisting of rotary potentiometer and push potentiometer.

According to some embodiments, the glass tube forming apparatus further comprises an external direct current source, that is located in series in the electrical connection between the tube forming body and the at least one electrode.

According to some embodiments, the tube forming body is A) a Danner mandrel or B) is a needle and an outlet nozzle.

According to some embodiments, the potential drop is generated at least partly by a difference of the metal of the metallic layer on the tube forming body and the metallic electrode, wherein the metals are selected from the group consisting of molybdenum, tungsten, tantalum, tin oxide, platinum, rhodium, iridium and alloys thereof, high melting refractory metals, oxides thereof and alloys thereof, oxide dispersion-strengthened metal compounds and alloys thereof, and heat-resistant steel, and optionally are selected from the group consisting of platinum, molybdenum tungsten and alloys thereof and oxide dispersion-strengthened metal compounds alloys thereof.

According to some embodiments, the direct current flows from the tube forming body to the at least one metallic electrode and optionally, the direct current density on the tube forming body is in the range from 0.05 mA/cm² to 5.0 mA/cm², optionally from 0.1 mA/cm² to 3.0 mA/cm² and optionally in the range from 0.5 to 2.0 mA/cm².

According to some embodiments, the glass tube has an aggregated air line length of less than 0.050 m per 1.0 m tube length on the surface of the inside of the glass tube, optionally less than 0.010 m per 1.0 m tube length on the surface of the inside of the glass tube, and optionally 0.0050 m per 1.0 m tube length on the surface of the inside of the glass tube or in the range of 0.00010 m to less than 0.10 m per 1.0 m tube length on the surface of the inside of the glass tube, optionally in the range of 0.00030 m to less than 0.050 m per 1.0 m tube length on the surface of the inside of the glass tube, optionally in the range of 0.00070 m to less than 0.010 m per 1.0 m tube length on the surface of the inside of the glass tube, and optionally in the range of 0.0010 m to less than 0.0050 m per 1.0 m tube length on the surface of the inside of the glass tube.

According to some embodiments, the glass tube has a glass composition comprising 60 to 85 wt.-% SiO₂, 5 to 20 wt.-% B₂O₃, 1 to 10 wt.-% Al₂O₃, 0 to 2 wt.-% Fe₂O₃, 2 to 10 wt.-% Na₂O, 0 to 5 wt.-% K₂O, 0 to 2 wt.-% BaO, 0 to 2 wt.-% CaO, 0 to 10 wt.-% TiO₂, based on all oxides present in the glass composition.

According to some embodiments, the glass tube has an outer diameter dₒ from 5 mm to 55 mm, optionally from 8 mm to 40 mm, optionally from 9 mm to 35 mm, optionally from 10 mm to 30 mm, and optionally from 11 mm to 25 mm, and/or a wall thickness WT from 0.4 mm to 2.5 mm, optionally from 0.6 mm to 2.3 mm, optionally from 0.8 mm to 2.1 mm, and optionally from 1.0 mm to 1.8 mm, and/or an inner diameter dᵢ from 4 to 51 mm, optionally from 6 mm to 46 mm, optionally from 10 mm to 41 mm, optionally from 16 mm to 40 mm, and optionally from 20 mm to 35 mm, and/or a length lₐ from 500 to 3500 mm, optionally from 800 to 3000 mm, and optionally from or 1200 to 2000 mm.

It should be understood that for the purpose of the present invention, the following terms have the following meaning:

If this disclosure refers to a length of any element, a width of any element or a height of any element, for example, refers to a length of a glass tube lₐ, an inner diameter dᵢ and outer diameter dₒ of a glass tube and a wall thickness WT of a glass tube, it shall be understood that with reference to a Cartesian coordinate system, length always refers to a maximal extension in the x-direction, width always refers to a maximal extension in the y-direction, and height always refers to a maximal extension in the z-direction, wherein the x-direction, y-direction and z-direction are oriented pairwise perpendicular to each other. Measurement of the lengths, the width or a height can be done for example by a microscope with calibrated size scala or a light box with a lineal.

A direct current (DC) in the meaning of the present invention, sometimes also known as galvanic current is a one-directional flow of electric charge. The direct current can be measured by a multimeter.

The viscosity of the glass melt in the meaning of the present invention is a measure of its resistance to deformation at a given rate, wherein the unit of the viscosity is Pa·s. Detailed definition of the viscosity of the glass melt is defined in detail in ISO 7884-1: Glass-Viscosity and viscometric fixed points, Part 1: “Principles for determining viscosity and viscometric fixed points”, Edition 1998-02. Measurement methods are described in ISO 7884-2: Glass-Viscosity and viscometric fixed points, Part 2: “Determination of viscosity by rotation viscometers”, Edition 1998-02.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which optionally consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined herein above.

According to the present invention, a glass tube forming apparatus is provided comprising a tube forming body configured to receive a flow of molten glass, wherein the molten glass is withdrawn from the forming body in form of a glass tube, and at least one metallic electrode, wherein the at least one metallic electrode is mounted in the glass melt in spaced relation to the tube forming body, wherein the tube forming body is covered at least partly with a metallic layer, and wherein the tube forming body is connected electrical with the at least one electrode. In the following, details and exemplary embodiments of the apparatus will be set out in more detail. It is to be understood that these technical details and embodiments also apply to the methods, the glass tube, and the use of said glass tube disclosed herein.

### Glass Tube Forming Apparatus

According to some embodiments, the present invention refers to a glass tube forming apparatus comprising:
a) a tube forming body configured to receive a flow of molten glass, wherein the molten glass is withdrawn from the forming body in form of a glass tube, and
b) at least one metallic electrode, wherein the at least one metallic electrode is mounted in the glass melt in spaced relation to the tube forming body, wherein the tube forming body is covered at least partly with a metallic layer, and wherein the tube forming body is connected electrical with the at least one electrode.

As set out above the glass tube forming apparatus comprises a tube forming body. A “tube forming body” in the meaning of the present invention is a component that is designed and suitable for receiving a flow of molten glass and withdrawing it from the tube forming body in form of a glass tube. The term “molten glass” or “glass melt” in the context of the present invention refers to a volume of a batch of glass raw materials that has a viscosity of less than 10^{7.6} dPa·s. The molten material is formulated such that with appropriate cooling, the material may form a glass, for example a silicate glass (e.g., borosilicate, alumino-borosilicate, aluminosilicate or lithium alumino-silicate (LAS) glass etc.). Generally, tube forming bodies are known to the skilled person who is familiar with glass production and especially with the production of glass tubes.

According to some embodiments, the tube forming body is A) a Danner mandrel or B) is a needle and an outlet nozzle.

In this description the terms “pipe” and “mandrel”, respectively “Danner pipe” and “Danner mandrel”, are synonymous. In the Danner method, which is known from U.S. Pat. No. 1,219,709, a so-called Danner mandrel is used as the tube forming body. This is a generally hollow, truncated cone shaping part often consisting of ceramic or metal material, which is arranged on a rotating carrier. The principal axis of the truncated cone shaping part is slightly tilted with respect to the horizontal. The glass melt is provided on the rotating shaping part at the upper end and it flows along the shaping part and is wound around the shaping part owing to the rotation. Due to the contact with the shaping part, the glass melt cools down. At the lower end of the shaping part, the viscous glass melt is drawn off as a so-called drawing bulb and then cooled further. The entire Danner mandrel is usually arranged in a temperature-controlled muffle furnace. For the manufacture of glass tubes, the carrier of the Danner mandrel is usually hollow in configuration and blowing air is blown in at the upper end of the carrier. The blowing air exits at the lower end of the carrier and prevents the glass melt from collapsing in the drawing bulb. The volume flow of the blowing air is slight and has a direct influence on the geometry of the resulting glass tube. Besides the blowing air, first and foremost the drawing speed of the glass melt has an influence on the geometry and especially on the outer diameter and the wall thickness of the glass tubes. A precise process control is needed here in order to uniformly produce a particular geometry. Danner mandrels are usually known in the prior art, for example from DE10048815C1, U.S. Pat. No. 3,360,353 or U.S. Pat. No. 3,523,782.

In the Vello and the down-draw method, the glass melt flows vertically downward (in the direction of gravity) through a tube forming body formed by a needle and an outlet nozzle. The tube forming body forms a negative mold (die) of the created cross section of the glass tube or glass rod. In the manufacture of glass tubes, a needle as the shaping part is normally arranged at the center of the tube forming body. Due to the contact with the needle and the outlet nozzle, the glass melt cools down. At the lower end of the needle, the viscous glass melt is drawn off as a so-called drawing bulb and then cooled further. The needle might be hollow in one configuration and blowing air is blown in at the upper end of the needle. The blowing air exits at the lower end of the needle and prevents the glass melt from collapsing in the drawing bulb. The volume flow of the blowing air is slight and has a direct influence on the geometry of the resulting glass tube. Besides the blowing air, first and foremost the drawing speed of the glass melt, and the diameter of the needle and of the outlet nozzle has an influence on the geometry and especially on the outer and inner diameter and the wall thickness of the glass tubes. A precise process control is needed here in order to uniformly produce a particular geometry. Such needles and outlet nozzles are usually known in the prior art, for example from DE10348098 A1 or from WO03018491A1.

The skilled person knows how to design or choose such a tube forming body dependent from the glass material that should be drawn and the inner and outer geometries of the glass tube.

The tube forming body can comprise or consist of any material that is suitable for preparing such tube forming bodies that are used for drawing glass tubes. Especially, the material has to be heat resistant, sufficiently dimensionally stable at the intended temperatures and relatively inert to the glass melt. Such materials are known to the skilled person, for example from U.S. Pat. No. 6,274,525B1 and are commercially available.

According to some embodiments, the tube forming body comprises or consists of a ceramic material. According to some embodiments, the ceramic material is a ceramic composite material and optionally is a bonded material. Optionally the ceramic composite material is a casting slip material, and the ceramic composite may comprise MgO—MgAl₂O₄. The ceramic material may comprise a coating, for example a metal coating such as a coating of platinum or a platinum group metal (PGM).

According to some embodiments, the tube forming body comprises or consists of a metal material. According to some embodiments, the metal material is a noble metal and/or an alloy thereof or a refractory metal, for example, a suitable high-temperature-resistant stainless steel, for example a nickel alloy with Mo, Cr or Co, optionally according to DIN 17744 or DIN EN 10095. Such high-temperature-resistant stainless steels are known to the skilled person and are commercially available, for example under the trade names THERMAX® or Stellite® 250 or Stellite®-21.

According to some embodiments, the tube forming body comprises or consists of a ceramic material and a metal material. It is optional that the main part, for example 80 vol % or more, of the tube forming body comprises or consists of a ceramic material and only a minor part, for example 20 vol % or less, of the tube forming body comprises or consists of a metal material. According to some embodiments, the tube forming body is a Danner mandrel and the upper part of the Danner mandrel comprises or consist of a ceramic material and the lower part of the Danner mandrel, which is also known as pipe head to the skilled person, comprises or consists of a metal material.

According to the present invention, the tube forming body is covered at least partly with a metallic layer. For example, at least 30% of the surface of the tube forming body are covered by a metallic layer, optionally 50%, optionally 70% and optionally 90%, based on the total surface of the tube forming body. According to some embodiments, the surface of the tube forming body that comes into contact with the glass melt is covered with a metallic layer. According to some embodiments, the complete surface of the tube forming body is covered with a metallic layer.

The covering of the tube forming body with the metallic layer can be done, for example by spray coating, dip coating, electrochemical deposition, wrapping with a foil or sheet of metal or by placing the tube forming body in a negative form, that comprises or consists of a metal. In case the tube forming body already comprises or consists of a metal material, the metallic layer may be the same or different than the metal of the tube forming body. Optionally the metal of the metallic layer is different than the metal of the tube forming body.

According to some embodiments, the metal of the metallic layer is the same as the metal of the tube forming body. In this case, the metallic layer defines the surface of the tube forming body and cannot be distinguished from the metal of the tube forming body.

The layer thickness of the metallic layer on the tube forming body is such that it is present on the tube forming body for the complete use of the tube forming body despite possible abrasion. According to some embodiments, the layer thickness of the metallic layer on the tube forming body is at least 100 μm, optionally at least 500 μm, optionally 1.0 mm, optionally 5.0 mm, optionally 10.0 mm and optionally 15.0 mm. According to some embodiments, the layer thickness of the metallic layer on the tube forming body is less than 50.0 cm, optionally less than 20.0 cm, optionally less than 15.0 cm, optionally less than 10.0 cm, optionally less than 5.0 cm, and optionally less than 3.0 cm. According to some embodiments, the layer thickness of the metallic layer on the tube forming body is between 100 μm and 50.0 cm, optionally between 200 μm and 20.0 cm, optionally between 500 μm and 15.0 cm, optionally between 800 μm and 10.0 cm, optionally between 1.0 mm and 5.0 cm and optionally between 1.5 mm and 3.0 cm. According to an exemplary embodiment, the layer thickness of the metallic layer on the tube forming body is about 1.0 mm.

According to some embodiments, the metal of the metallic layer on the tube forming body is selected from the group consisting of molybdenum, tungsten, tantalum, tin oxide, platinum, rhodium, iridium, and alloys thereof, high melting refractory metals, oxides thereof and alloys thereof, oxide dispersion-strengthened metal compounds and alloys thereof, and heat-resistant steel.

In case the metal of the metallic layer on the tube forming body is tantalum, tungsten and/or molybdenum, the process of withdrawing the glass and forming the glass tube has to be done under a protective atmosphere such as nitrogen atmosphere.

According to some embodiments, the metal of the metallic layer on the tube forming body is selected from the group consisting of platinum, rhodium, iridium, and alloys thereof, high melting refractory metals, oxides thereof and alloys thereof, oxide dispersion-strengthened metal compounds and alloys thereof, and heat-resistant steel. Optionally, the metal of the metallic layer on the tube forming body is selected from the group consisting of platinum, molybdenum, tungsten and alloys thereof and oxide dispersion-strengthened metal compounds and alloys thereof. Optionally the metal of the metallic layer on the tube forming body is platinum or platinum alloy or an oxide dispersion-strengthened platinum alloy. Optionally the metal of the metallic layer on the tube forming body is an alloy of platinum with iridium or rhodium or is an oxide dispersion-strengthened platinum compound or an oxide dispersion-strengthened platinum-rhodium or platinum-iridium alloy.

Molybdenum (Mo), tungsten (W), tantalum (Ta), platinum (Pt), rhodium (Rh) and iridium (Ir) are metals and are commercially available. If the description refers to the metal itself, this means that the compound is in the elemental state and does not comprise any further compounds and, therefore, is essentially free of further components. It should be noted that if this description refers to a metal which is essentially free of a component or does not contain a certain component or includes the hypothetical case of 0 weight % of that component, it is to be understood that this component may at most be present as an impurity. This means that it is not added in significant quantities and that it is not added intentionally. The term “component” refers to the elemental species as such as well as any molecule containing the element. Non-essential amounts are to be understood as less than 100 ppm, optionally less than 50 ppm, and optionally less than 10 ppm, based on the weight percentage with respect to all intentionally added components.

Alloys of molybdenum, tungsten, tantalum, tin oxide, platinum, rhodium and/or iridium are alloys that comprise at least one of the forementioned in an amount of at least 50 mol.-% based on the total amount of the alloy. However, the alloy might comprise further compounds such as rhenium or copper or ruthenium. Known alloys are, for example, molybdenum-rhenium alloys, molybdenum-copper alloys, tungsten-carbide, tungsten-rhenium alloys, tantalum-niobium alloys, tantalum-hafnium alloys, platinum-rhodium alloys, platinum-iridium alloys, iridium-ruthenium alloys and are commercially available. Especially platinum-1-iridium alloys or platinum-6-rhodium-alloys and platinum-10-rhodium-alloys are known to the skilled person and commercially available.

High melting refractory metals are metals that have a melting point above 2000° C. and a high hardness at room temperature. Known high melting refractory metals are niobium, molybdenum, tantalum, tungsten and rhenium. Oxides of high melting refractory metals such as niobium, molybdenum, tantalum, tungsten and rhenium are compounds of these metals and oxygen. Such oxides are niobium oxides such as niobium pentoxide (Nb₂O₅), molybdenium oxides such as molybdenum trioxide (MoO₃), tantalum oxides such as tantalum pentoxide (Ta₂O₅), tungsten oxides such as tungsten trioxide (WO3) or rhenium oxides such as rhenium oxide (ReO₃), which are commercially available. Alloys of high melting refractory metals are alloys that comprise at least one high melting refractory metal in an amount of at least 50 mol.-% based on the total amount of the alloy. However, the alloy might comprise further compounds. Known alloys of high melting refractory metals are, for example, molybdenum-rhenium alloys, molybdenum-copper alloys, tungsten-carbide, tungsten-rhenium alloys, tantalum-niobium alloys, tantalum-hafnium alloys and are commercially available.

Oxide dispersion-strengthened metal compounds and alloys thereof are compounds that comprise fine oxide particles distributed within the metal or metal alloy matrix. Optionally the fine oxide particles, for example yttrium oxide particles (Y₂O₃) are distributed within the metal or metal alloy matrix mainly on the grain boundaries. Optionally the oxide dispersion-strengthened metal compounds are oxide dispersion-strengthened platinum compounds or oxide dispersion-strengthened zirconium compounds. Oxide dispersion-strengthened platinum compounds are known to the skilled person and commercially available, for example, from Heraeus under the trade name DPH. Oxide dispersion-strengthened zirconium compounds are known from U.S. Pat. No. 3,775,823A.

Heat-resistant steel is a type of steel designed to withstand high temperatures without losing its mechanical properties and is known to the skilled person and commercially available. Optionally a heat-resistant stainless steel is used, for example a nickel alloy with Mo, Cr or Co, optionally according to DIN 17744 or DIN EN 10095. Such high-temperature-resistant stainless steels are known to the skilled person and are commercially available, for example, under the trade name THERMAX® or Stellite® 250 or Stellite®-21.

The glass tube forming apparatus provided according to the present invention comprises at least one metallic electrode, wherein the at least one metallic electrode is mounted in the glass melt in spaced relation to the tube forming body. At least one metallic electrode in the meaning of the present invention means that the glass tube forming apparatus comprises one or more electrodes, for example one, or two, or three, or six, or eight, or more electrodes. According to some embodiments, the glass tube forming apparatus provided according to the present invention comprises between one to eighty metallic electrodes, for example between 5 to 30 metallic electrodes or between 40 to 60 metallic electrodes.

The metallic electrodes of the glass tube forming apparatus might be installed in the glass melt merely for the glass tube forming apparatus. Alternatively, metallic electrodes might be used that are already present in the glass melt, for example, heating electrodes, that are used for melting the glass raw materials or heating the glass melt.

According to some embodiments, the at least one metallic electrode is mounted in the melting vessel and/or the fining vessel and/or working tank and/or distributor. According to some embodiments, the at least one metallic electrode is mounted in the melting vessel.

In case more than one metallic electrode is present in the tube forming apparatus, all the metallic electrodes are present in the same part, or in different parts. For example, if two or more metallic electrodes are present in the tube forming apparatus, all the metallic electrodes are present in one part, for example all the metallic electrodes are present in the melting vessel or in the working tank. Alternatively, if two or more metallic electrodes are present in the tube forming apparatus, the metallic electrodes are in different parts, for example, some of the metallic electrodes are present in the melting vessel and some of the metallic electrodes are present in the fining vessel.

According to some embodiments, the at least one metallic electrode is mounted in the melting vessel. This may be especially preferred since in that case the ions that might migrate from the at least one electrode into the glass melt in the melting vessel might be oxidized/reduced or chemically reacted in the glass melt and might no longer be detectable in the obtained product.

According to some embodiments, the metal of the at least one metallic electrode is selected from the group consisting of molybdenum, tungsten, tantalum, tin oxide, platinum, rhodium, iridium, and alloys thereof, high melting refractory metals, oxides thereof and alloys thereof, oxide dispersion-strengthened metal compounds and alloys thereof, and heat-resistant steel, and optionally is selected from the group consisting of platinum, molybdenum, tungsten and alloys thereof and oxide dispersion-strengthened metal compounds and alloys thereof and optionally, is molybdenum or tungsten or an oxide dispersion-strengthened molybdenum or tungsten alloy.

The metallic layer on the tube forming body and the metallic electrode may be the same or may be different metals. According to some embodiments, the metallic layer on the tube forming body and the metallic electrode are different metals. According to some embodiments, the metal of the metallic layer on the tube forming body and the metallic electrode are different metals and are selected from the group consisting of platinum, molybdenum, tungsten and alloys thereof as well as oxide dispersion-strengthened alloys and compounds thereof and optionally the metal of the metallic layer on the tube forming body is platinum or platinum alloy or an oxide dispersion-strengthened platinum alloy and the metal of the metallic electrode is molybdenum or tungsten or an oxide dispersion-strengthened molybdenum or tungsten alloy.

According to some embodiments, the tube forming body is connected electrical with the at least one electrode.

An “electrical connection” in the meaning of the present invention is a device that connects directly or via other components the tube forming body with the at least one electrode such that an electric current can flow. The electrical connection can be any device that can conduct electricity in a suitable amount. For example, the electrical connection can be a wire, a cable, conductive tape, or any other metallic device that is suitable for conducting electricity. In some embodiments, the electrical connection is a wire or a cable, and optionally the wire or cable are isolated on the outside by an insulator such as, for example, PVC, rubber, PE or PTFE.

The electrical connection can be one connection or more connections. According to some embodiments, the electrical connection is merely one connection, for example, one wire or cable, that connects the tube forming body with the at least one electrode. Alternatively, the electrical connections are more than one connection, that are arranged parallel or in series, and optionally parallel, to connect the tube forming body with the at least one electrode. Such electrical connections like wire or cable are known to the skilled person and commercially available. According to some embodiments, a standard commercial cable or wire with a cross-section of 1 to 4 mm is used.

The electrical connection is designed such that a direct current in a suitable amount can flow. A direct current (DC) in the meaning of the present invention, sometimes also known as galvanic current is one-directional flow of electric charge. The electric current flows in a constant direction, distinguishing it from alternating current (AC). In the present invention, the electrons flow in the electrical connection between the metallic electrode and the tube forming body from the metallic electrode to the tube forming body. Therefore, a positive electric current flows in opposite direction to the electrons, i.e. within the electrical connection from the tube forming body to the at least one metallic electrode.

In addition to the above-mentioned components, the glass tube forming apparatus might comprise further optional components.

According to some embodiments, the glass tube forming apparatus further comprises an electronic voltage filter. The electronic voltage filter might be located in series in the electrical connection between the tube forming body and the at least one electrode. An “electronic voltage filter” in the meaning of the present invention is a device that can filter or block unwanted frequencies from the applied signal, can enhance unwanted ones or both.

According to some embodiments, the electronic voltage filter is a filter, that converts alternating current (AC) that might flow through the electrical connection between the tube forming body to the at least one metallic electrode to direct current (DC).

According to some embodiments, the electronic voltage filter is a high pass electronic filter that passes signals with a frequency higher than a certain cutoff frequency and attenuates signals with frequencies lower than the cutoff frequency. For example, such a high pass electronic filter might only pass frequencies that are higher than a cutoff frequency of 60 Hz, or 70 Hz, or 120 Hz. According to some embodiments, the electronic voltage filter is a low pass electronic filter that passes signals with a frequency lower than a selected cutoff frequency and attenuates signals with frequencies higher than the cutoff frequency. For example, such a low pass electronic filter might only pass frequencies that are lower than a cutoff frequency of 40 Hz, or 55 Hz, or 100 Hz. According to some embodiments, the electronic voltage filter is a band-stop filter or band-rejection filter that passes most frequencies unaltered but attenuates those in a specific range to very low levels. For example, such a band-stop filter attenuates frequencies in the range of about 50 Hz, or 60 Hz, or 110 Hz, especially in the range of 45 Hz to 55 Hz, or 55 Hz to 65 Hz, or 105 Hz to 115 Hz to very low levels and optionally to zero.

One or more electronic voltage filters might be used in the glass tube forming apparatus. For example, one electronic voltage filter is a filter, that converts alternating current (AC) to direct current (DC) and another electronic voltage filter is a band-stop filter, optionally a band-stop filter that attenuates frequencies in the range of about 50 Hz. Such filters might be arranged parallel or in series and optionally are arranged in series.

Electronic voltage filters are known to the skilled person and are commercially available. For example, the electronic voltage filter comprises or consists of a resistor, a capacitor and/or an inductance. A resistor in the meaning of the present invention is a passive two-terminal electrical component that implements electrical resistance as a circuit element. A capacitor in the meaning of the present invention is a device that stores electrical energy by accumulating electric charges on two closely spaced surfaces that are insulated from each other. An inductance in the meaning of the present invention is an electrical conductor such as a wire in the shape of a coil.

According to some embodiments, the glass tube forming apparatus further comprises an electronic voltage adjustment or electronic voltage control. The electronic voltage adjustment or electronic voltage control can be located in series in the electrical connection between the tube forming body and the at least one electrode. An electronic voltage adjustment in the meaning of the present invention is a device, that sets the voltage to a defined value which cannot be amended. An electronic voltage control in the meaning of the present invention is a device, that can be used to regulate the voltage to obtain a variable voltage in output. Electronic voltage adjustments and electronic voltage controls are known to the skilled person and are commercially available.

According to some embodiments, an electronic voltage control is located in series in the electrical connection between the tube forming body and the at least one electrode, which is optionally a variable resistor. A variable resistor in the meaning of the present invention is an electronic component that allows to control the flow of voltage by changing the amount of resistance. Optionally, the electronic voltage control is selected from the group consisting of a rotary potentiometer and push potentiometer. A rotary potentiometer in the meaning of the present invention is a variable resistor that can be moved by a rotary motion. A push potentiometer in the meaning of the present invention is a potentiometer that is attached on top of a switch and can be turned “on” or “off” by operating the switch. According to an exemplary embodiment, the electronic voltage control is a rotary potentiometer.

According to some embodiments, the glass tube forming apparatus further comprises an external direct current source. The external direct current source can be located in series in the electrical connection between the tube forming body and the at least one electrode. An external direct current source in the meaning of the present invention is a current source that is connected externally and provides a further direct current in addition to the currents(s) that are already present in the system. Such direct current sources are known to the skilled person and are commercially available.

The glass tube forming apparatus might comprise only one optional component, or more components, for example, two or three further components.

A main difference between the tube forming apparatus provided according to the present invention and apparatuses already known is that there is no contact or connection of the tube forming body with the remaining components that are used for melting and withdrawing glass, such as the glass tank or the stirrer within that tank or the melting vessel or the melting channel, apart from the contact via the electrical connection with the metallic electrode. Rather, the connection between these two components is only created by the liquid glass melt, which can conduct electricity.

### Method

According to one aspect of the present invention, a method for reducing the amount of gas bubbles on the contact surface of a glass tube is provided.

A “bubble” or “gas bubble” in the meaning of the present invention is a gaseous inclusion within the glass or the glass melt of at least 10 μm, wherein the size or size range refers to the diameter of a sphere with a volume equivalent that of the gaseous inclusion, respectively the bubble. The “diameter” means the largest diameter of the gaseous inclusion. Whenever in this description reference is made to “bubble” it can be understood as gas bubble in its broadest meaning. The gas in the gas bubble is mainly oxygen (O₂) that forms, for example, through the decomposition of water or the splitting of OH-groups bound to individual melt components and their decomposition as described above. The gas bubble comprises at least 90 vol % of oxygen based on the total volume of the gas bubble, optionally 98 vol % of oxygen based on the total volume of the gas bubble and optionally consists only of oxygen. The number of bubbles can be detected, for example, simply by visual inspection and counting by quality personal. Alternatively, the number of bubbles can be detected by an online inspection system, for example by a camera and a visual counting software.

The method for reducing the amount of gas bubbles on the contact surface of a glass tube comprises the steps of
i) providing a tube forming body, configured to receive a flow of molten glass, wherein the tube forming body is covered at least partly with a metallic layer, and
ii) providing at least one metallic electrode, wherein the at least one metallic electrode is mounted in the glass melt in spaced relation to the tube forming body,
iii) providing an electrical connection between the tube forming body and the at least one electrode,
iv) generating a potential drop between the tube forming body and the at least one electrode to cause a direct current and
v) withdrawing the molten glass from the tube forming body in form of a glass tube during the direct current flows between the tube forming body and the at least one electrode.

Steps i), ii) and iii) have already been described in detail above for the glass tube forming apparatus. It is to be understood that these technical details and embodiments also apply to the methods disclosed herein.

According to step iv) a potential drop is generated between the tube forming body and the at least one electrode to cause a direct current.

According to some embodiments, the potential drop is generated at least partly by a difference of the metal of the metallic layer on the tube forming body and the metallic electrode. The possible metals of the metallic layer on the tube forming body and the metallic electrode have already been described in detail above and optionally are selected from the group consisting of molybdenum, tungsten, tantalum, tin oxide, platinum, rhodium, iridium and alloys thereof, high melting refractory metals, oxides thereof and alloys thereof, oxide dispersion-strengthened metal compounds and alloys thereof, and heat-resistant steel, and optionally are selected from the group consisting of platinum, molybdenum tungsten and alloys thereof and oxide dispersion-strengthened metal compounds alloys thereof.

According to some embodiments, the potential drop is generated at least partly by a temperature difference between the temperature of the glass melt on the tube forming body and the temperature of the glass melt at the position of the at least one metallic electrode. For example, the at least one metallic electrode is mounted in the melting vessel and/or the fining vessel and/or working tank and/or distributor, and optionally is mounted in the melting vessel. The glass melt in the melting vessel and/or the fining vessel might have a temperature in the range of 1500 to 1650° C., and/or the glass melt in the working tank and/or distributor might have a temperature in the range of 1450 to 1550° C. and/or the glass melt on the tube forming body might have a temperature in the range of 900 to 1250° C. Therefore, the temperature difference between the glass melt on the tube forming body and the temperature of the glass melt at the position of the at least one metallic electrode is at least 50° C., optionally at least 100° C. optionally at last 150° C. and optionally at least 180° C. or the temperature difference is in the range of 50° C. to 450° C., optionally 100° C. to 400° C., optionally 150° C. to 350° C. and optionally 180° C. to 250° C.

According to some embodiments, the potential drop is generated at least partly by an external direct current source, that is located in series in the electrical connection between the tube forming body and the at least one electrode. According to some embodiments, the external direct current has an amount of 5.0 V or less, optionally 2.0 V or less, optionally 1.0 V or less, and optionally 0.50 V or less. According to some embodiments, the external direct current has an amount of between more than 0 V to 5.0 V or less, optionally between 10 mV and 2.0 V, optionally between 50 mV and 1.0 V and optionally between 100 mV and 500 mV, for example about 120 mV, or about 130 mV or about 160 mV or about 200 mV or about 210 mV or about 260 mV.

The potential drop can be generated only by one or more measures. According to some embodiments, the potential drop is generated only by a difference of the metal of the metallic layer on the tube forming body and the metallic electrode. According to some embodiments, the potential drop is generated only by a temperature difference between the temperature of the glass melt on the tube forming body and the temperature of the glass melt at the position of the at least one metallic electrode. According to some embodiments, the potential drop is generated only by an external direct current source, that is located in series in the electrical connection between the tube forming body and the at least one electrode. According to some embodiments, the potential drop is generated by a combination of two measures, namely by a difference of the metal of the metallic layer on the tube forming body and the metallic electrode and by a temperature difference between the temperature of the glass melt on the tube forming body and the temperature of the glass melt at the position of the at least one metallic electrode. Alternatively, the potential drop is generated by a combination of a difference of the metal of the metallic layer on the tube forming body and the metallic electrode and an external direct current source, that is located in series in the electrical connection between the tube forming body and the at least one electrode. Alternatively, the potential drop is generated by a combination of a temperature difference between the temperature of the glass melt on the tube forming body and the temperature of the glass melt at the position of the at least one metallic electrode and an external direct current source, that is located in series in the electrical connection between the tube forming body and the at least one electrode. Alternatively, the potential drop is generated by all three measures described above.

Due to the potential drop between the tube forming body and the at least one electrode a direct current is caused to flow. As already set out above, a direct current (DC) in the meaning of the present invention, sometimes also known as galvanic current is one-directional flow of electric charge. The electric current flows in a constant direction, distinguishing it from alternating current (AC). In the present invention, the electrons flow in the electrical connection between the metallic electrode and the tube forming body from the metallic electrode to the tube forming body. Therefore, a positive electric current flows in opposite direction to the electrons, i.e. within the electrical connection from the tube forming body to the at least one metallic electrode.

According to some embodiments, the direct current flows from the tube forming body to the at least one metallic electrode and the direct current density on the tube forming body is in the range from 0.05 mA/cm² to 5.0 mA/cm², optionally from 0.1 mA/cm² to 3.0 mA/cm² and optionally in the range from 0.5 to 2.0 mA/cm². The direct current density (j) in the meaning of the present invention is defined by the formula

$$j = I / A$$

wherein I is the direct current in the glass melt on the tube forming body and A is defined by the formula

$$A = π \cdot {d}_{tube forming body} \cdot L$$

wherein d_{tube forming body} is the diameter of the tube forming body that is covered with the metallic layer and L is the section on the tube forming body wherein the molten glass occurs on the tube forming body to where the temperature in the glass melt on the tube forming body is such that the viscosity of the glass is below the so-called softening point of 10^{7.6} d·Pas.

According to step v) the molten glass is withdrawn from the tube forming body in form of a glass tube during the direct current flows between the tube forming body and the at least one electrode. Withdrawing of molten glass from the tube forming body in form of a glass tube is a known process and the skilled person knows how to adjust the parameters such as temperature, drawing speed, rotation of the glass tube, etc.

The inventors have surprisingly found that by the above-described apparatus and method it is possible to reduce or even avoid the gas bubble formation, especially the formation of oxygen-containing bubbles, on the contact surface of a glass tube. Without being bound to any theory, it is believed that due to the generation of the potential drop between the tube forming body and the at least one electrode a direct current is caused that flows between the tube forming body and the at least one electrode. That direct current has a direct influence on the oxygen partial pressure in the glass melt, especially on the glass melt at the point of the tube forming body as can be seen from the below reaction.

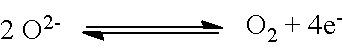

The oxygen partial pressure can be measured directly in the glass melt. This kind of measurement is known and performed, for example, with probes as described by Th. Frey and F. G. K. Baucke, et al, in Glastechn. Ber. 53, pp. 116-123 (1980). It is believed that the direct current that flows between the tube forming body and the at least one electrode leads to a shift of the above reaction scheme to the left side and, therefore, to a reduction of the oxygen partial pressure in the glass melt at the tube forming body. The inventors believe that, due to that reduction of the oxygen partial pressure, the amount of gas bubbles in the glass melt at the tube forming body and, therefore, also on the contact surface of a glass tube is reduced.

According to some embodiments, the oxygen partial pressure in the glass melt on the tube forming body is less than 1.0 bar, optionally less than 0.8 bar and optionally less than 0.5 bar. According to some embodiments, the oxygen partial pressure in the glass melt on the tube forming body is between 0.01 bar to less than 1.0 bar, optionally between 0.05 bar to less than 0.8 bar and optionally between 0.1 bar to less than 0.5 bar.

By the method provided according to the present invention, it is possible to reduce the amount of gas bubbles in the molten glass on the tube forming body and, therefore, on the contact surface of a glass tube.

According to some embodiments, the glass tube or glass melt on the tube forming body has less than 80 bubbles in a size range of from 0.1 mm to 0.3 mm per 10 kg of glass and/or less than 2 bubbles of a size larger than 0.3 mm per 10 kg of glass. According to some embodiments, the glass tube or glass melt on the tube forming body has less than 80 bubbles, less than 60 bubbles, less than 40 bubbles, or less than 20 bubbles, in a size range of from 0.1 mm to 0.3 mm per 10 kg of glass. In some embodiments, the glass tube or glass melt on the tube forming body has 0 bubbles, at least 2 bubbles, at least 5 bubbles, or at least 10 bubbles, in a size range of from 0.1 mm to 0.3 mm per 10 kg of glass. In some embodiments, the glass tube or glass melt on the tube forming body has 0 to 80 bubbles, 2 to 60 bubbles, 3 to 40 bubbles, 4 to 20 or 5 to 15 bubbles, in a size range of from 0.1 mm to 0.3 mm per 10 kg of glass. The indication of a number of bubbles per 10 kg of glass does not mean that the glass product must have a mass of at least 10 kg. Thus, the number of bubbles per mass unit may be measured in smaller samples as well, e.g. a sample of 1 kg or 100 g.

In some embodiments, the glass tube or glass melt on the tube forming body has less than 2 bubbles of a size larger than 0.3 mm per 10 kg of glass, or 0 bubbles of a size larger than 0.3 mm per 10 kg of glass. In some embodiments, the glass tube or glass melt on the tube forming body has 0 to 80 bubbles, 2 to 60 bubbles, 3 to 40 bubbles, 4 to 20 or 5 to 15 bubbles, in a size range of from 0.1 mm to 0.3 mm per 10 kg of glass and less than 2 bubbles of a size larger than 0.3 mm per 10 kg of glass.

In some embodiments, the glass tube or glass melt on the tube forming body has 0 to 80 bubbles, 2 to 60 bubbles, 3 to 40 bubbles, 4 to 20 or 5 to 15 bubbles, in a size range of from 0.1 mm to 0.3 mm per 10 kg of glass and 0 bubbles of a size larger than 0.3 mm per 10 kg of glass. This may be especially advantageous since, due to the reduced oxygen bubble formation on the surface of a glass tube, it is possible to produce glass tubes with a reduced amount of aggregated air line length, especially with an aggregated air line length of less than 0.10 m per 1.0 m tube length on the contact surface of the glass tube as described below.

Additionally, or alternatively, the glass tube or glass melt on the tube forming body has less than 80 bubbles in a size range of from 0.01 mm to below 0.3 mm per 10 kg of glass. According to some embodiments, the glass tube or glass melt on the tube forming body has less than 80 bubbles, less than 60 bubbles, less than 40 bubbles, or less than 20 bubbles, in a size range of from 0.01 mm to below 0.3 mm per 10 kg of glass. In some embodiments, the glass tube or glass melt on the tube forming body has 0 bubbles, at least 2 bubbles, at least 5 bubbles, or at least 10 bubbles, in a size range of from 0.01 mm to below 0.3 mm per 10 kg of glass. In some embodiments, the glass tube or glass melt on the tube forming body has 0 to 80 bubbles, 2 to 60 bubbles, 3 to 40 bubbles, 4 to 20 or 5 to 15 bubbles, in a size range of from 0.01 mm to below 0.3 mm per 10 kg of glass. The indication of a number of bubbles per 10 kg of glass does not mean that the glass product must have a mass of at least 10 kg. Thus, the number of bubbles per mass unit may be measured in smaller samples as well, e.g. a sample of 1 kg or 100 g.

One possible advantage of the above method and apparatus is that it is easy to handle, economic, since existing apparatuses can be used to a large extent and only require a small amount of conversion, and environmentally friendly, since no additional chemicals are used in the glass melt. Furthermore, the time for drawing and further processing of the tubes is not affected.

### Glass Tube and Applications

According to a further aspect of the present invention, a glass tube obtainable by the method provided according to the present invention is provided. Especially, a glass tube is provided by the method comprising the steps of
i) providing a tube forming body, configured to receive a flow of molten glass, wherein the tube forming body is covered at least partly with a metallic layer, and
ii) providing at least one metallic electrode, wherein the at least one metallic electrode is mounted in the glass melt in spaced relation to the tube forming body,
iii) providing an electrical connection between the tube forming body and the at least one electrode,
iv) generating a potential drop between the tube forming body and the at least one electrode to cause a direct current and
v) withdrawing the molten glass from the tube forming body in form of a glass tube during the direct current flows between the tube forming body and the at least one electrode.

According to some embodiments, a glass tube having an aggregated air line length of less than 0.10 m per 1.0 m tube length on the contact surface of the glass tube is provided, wherein the aggregated air line length is defined as the sum of the lengths of closed air lines having a length>15 mm and open air lines having a length>2 mm.

The contact surface in the meaning of the present invention is the surface of the glass tube that has been in direct contact with the metal on the tube forming body. The surface of the glass tube in the meaning of the present invention is the volume of the glass tube below the interface of the glass tube with the surrounding up to 0.3 mm deep into the glass tube. In case the thickness of the glass tube is less than 0.6 mm, the contact surface of the glass tube refers to the complete glass volume of the glass tube.

The unit “m per 1 m tube length” of the aggregated air line length does not mean that the glass tubes have a length of 1 m or above. They may have any desired length. The aggregated air line length can be determined for a tube of a given length and then be recalculated to a length of 1 m.

While the disclosed method reduces the amount of gas bubbles on the contact surface of a glass tube, a small volume of gas bubbles may still remain in the glass and finally end up in the glass tubes. During the drawing process, these bubbles are stretched and form open or closed air lines. “Open air lines” in the meaning of the present invention are air lines that are not closed to the surrounding area and, therefore, have rather the shape of an incision. “Closed air lines” in the meaning of the present invention are air lines where the gas bubbles have not been opened to the surrounding during the drawing process. Bubbles and air lines can be detected in the glass by visual inspection, in particular automated visual inspection. The aggregated air line length is the total length of all the air lines within a certain length of the glass tube meeting certain dimensional criteria. Within this disclosure, all closed air lines having a length>15 mm and all open air lines having a length>2 mm are counted for the aggregated air line length. When working according to this disclosure, a particularly low value of the aggregated air line length can be achieved, which is a sign of a high-quality glass product.

According to some embodiments, the glass tube has an aggregated air line length of less than 0.050 m per 1.0 m tube length on the surface of the inside of the glass tube, optionally less than 0.010 m per 1.0 m tube length on the surface of the inside of the glass tube, and optionally 0.0050 m per 1.0 m tube length on the surface of the inside of the glass tube.

According to some embodiments, the glass tube has an aggregated air line length in the range of 0.00010 m to less than 0.10 m per 1.0 m tube length on the surface of the inside of the glass tube, optionally in the range of 0.00030 m to less than 0.050 m per 1.0 m tube length on the surface of the inside of the glass tube, optionally in the range of 0.00070 m to less than 0.010 m per 1.0 m tube length on the surface of the inside of the glass tube, and optionally in the range of 0.0010 m to less than 0.0050 m per 1.0 m tube length on the surface of the inside of the glass tube.

Alternatively, the aggregated air line length can be recalculated for a length of 10 m. For example, the glass tube provided according to the present invention has an aggregated air line length of less than 1.0 m per 10.0 m tube length on the contact surface of the glass tube, optionally of less than 0.50 m per 10.0 m tube length on the surface of the inside of the glass tube, optionally less than 0.10 m per 10.0 m tube length on the surface of the inside of the glass tube, and optionally 0.050 m per 10.0 m tube length on the surface of the inside of the glass tube or less than 0.010 m per 10.0 m tube length on the surface of the inside of the glass tube.

According to some embodiments, the glass tube has an aggregated air line length in the range of 0.0010 m to less than 1.0 m per 10.0 m tube length on the surface of the inside of the glass tube, optionally in the range of 0.0030 m to less than 0.50 m per 10.0 m tube length on the surface of the inside of the glass tube, optionally in the range of 0.0070 m to less than 0.10 m per 10.0 m tube length on the surface of the inside of the glass tube, and optionally in the range of 0.010 m to less than 0.050 m per 10.0 m tube length on the surface of the inside of the glass tube or in the range of 0.0010 m to less than 0.010 m per 10.0 m tube length on the surface of the inside of the glass tube.

The aggregated air line length can be detected, for example, simply by visual inspection and measuring with a suitable scale by quality personal. Alternatively, the aggregated air line length can be detected by an online inspection system, for example by a camera and a visual measuring software.

Within the present disclosure, the glass tube has an inner surface and an outer surface. The “inner surface of the glass tube” in the meaning of the present invention is the surface on the inside of the glass tube. The “outer surface of the glass tube” in the meaning of the present invention is the surface on the outside of the glass tube. The edges of the glass tube dₒ not count to the surface of the glass tube.

The glass tube can be characterized by an inner diameter dᵢ, an outer diameter dₒ, a wall thickness WT and a length lₐ along its longitudinal axis.

According to some embodiments, the glass tube may have an outer diameter dₒ from 5 mm to 55 mm, optionally from 8 mm to 40 mm, optionally from 9 mm to 35 mm, optionally from 10 mm to 30 mm, and optionally from 11 mm to 25 mm.

Additionally, or alternatively, the glass tube may have an inner diameter dᵢ from 4 mm to 51 mm, optionally from 6 mm to 46 mm, optionally from 10 mm to 41 mm, optionally from 16 mm to 40 mm, and optionally from 20 mm to 35 mm.

Alternatively, the glass tube might have an inner diameter d₁ of 0 mm. Such glass tubes are also known as glass rods. In that case the “inner surface of the glass tube” is collapsed and forms the so-called “central core” of the glass.

Additionally, or alternatively, the glass tube may have a wall thickness WT from 0.4 mm to 2.5 mm, optionally from 0.6 mm to 2.3 mm, optionally from 0.8 mm to 2.1 mm, and optionally from 1.0 mm to 1.8 mm.

Additionally, or alternatively, the glass tube may have a length lₐ from 500 to 3500 mm, optionally from 800 to 3000 mm, and optionally from 1200 to 2000 mm.

According to some embodiments, the glass tube may have an outer diameter dₒ from 5 mm to 55 mm, an inner diameter dᵢ from 4 to 51 mm, and a length lₐ from 500 to 3500 mm. According to some embodiments, the glass tube may have an outer diameter dₒ from 5 mm to 55 mm, an inner diameter dᵢ from 4 to 51 mm, and a length lₐ from 500 to 3500 mm and a wall thickness WT from 0.4 mm to 2.5 mm.

According to an exemplary embodiment, the glass tube may have an outer diameter dₒ of 6.85 mm and an inner diameter d₁ of 4.65 mm, or an outer diameter dₒ of 8.15 mm and an inner diameter d₁ of 6.35 mm, or an outer diameter dₒ of 8.65 mm and an inner diameter dᵢ of 6.85 mm, or an outer diameter dₒ of 10.85 mm and an inner diameter d₁ of 8.65 mm, or an outer diameter dₒ of 10.95 mm and an inner diameter d₁ of 9.25 mm, or an outer diameter dₒ of 11.60 mm and an inner diameter d₁ of 9.65 mm, or an outer diameter dₒ of 14.00 mm and an inner diameter d₁ of 12.00 mm, or an outer diameter dₒ of 14.45 mm and an inner diameter d₁ of 11.85 mm, or an outer diameter dₒ of 17.05 mm and an inner diameter d₁ of 14.25 mm, or an outer diameter dₒ of 18.25 mm and an inner diameter d₁ of 16.05 mm, or an outer diameter dₒ of 22.05 mm and an inner diameter d₁ of 19.05 mm.

The skilled person knows how to measure the outside diameter, the inside diameter, the wall thickness and the length of the glass tubes and selects suitable measuring equipment depending on the type and size of the object to be measured and on the accuracy with which the object and thus also the tolerance are to be determined. Such measuring equipment is commercially available, e.g. micrometers, calipers or two-point probe heads, or optical measuring instruments, e.g. digital measuring projectors. Digital measuring projectors are available from companies such as KEYENCE.

Any glass composition that might be used in a Danner or Vello or Down-draw method might be used for preparing the glass tubes provided according to the present invention. Especially, the glass composition may be borosilicate, alumino-borosilicate, aluminosilicate or lithium aluminosilicate (LAS) glass composition.

Where reference is made to “glass composition”, it is to be understood as the oxide composition of the glass after melting the batch of glass raw materials and solidifying the melt to obtain the glass tube. This means that any volatile components are in the gaseous state and that the metals and metalloids are present in the glass compositions as oxides and/or fluorides and/or chlorides. In other words, the “glass composition” is the combination of oxides and/or fluorides and/or chlorides that can be obtained by melting a glass tube.

A “glass melt” is a mixture of glass raw materials that have already been transformed into a glass that has a viscosity of less than 10^{7.6} dPas. The viscosity can for example be measured using a rotational viscosimeter, e.g. as described in DIN ISO 7884-2:1998-2. The dependence of the viscosity on the temperature is described according to the VFT equation (Vogel-Fulcher-Tammann).

“Glass raw materials” shall be understood as any chemical component that is suitable, in combination with other similar components, to form a glass melt and, optionally after reactions have taken place in the glass melt, a glass product. Examples of glass raw materials used in the context of the invention include, but are not limited to, the oxides of metals and metalloids, the nitrates of metals and metalloids, and the carbonates of metals and metalloids.

When reference is made to the “wt.-%” in this context, this should be understood as weight percent based on the total weight of the glass composition if not indicated otherwise.

If this description refers to a glass composition which is essentially free of a component or does not contain a certain component or includes the hypothetical case of 0 weight % of that component, it is to be understood that this component may at most be present as an impurity. This means that it is not added in significant quantities and that it is not added intentionally. The term “component” refers to the elemental species as such as well as any molecule containing the element. Non-essential amounts are to be understood as less than 100 ppm, optionally less than 50 ppm, and optionally less than 10 ppm, based on the weight percentage with respect to all intentionally added components.

Where reference is made to “ppm” in the context of solids or liquids, this should be understood as ‘weight/weight’ (w/w). Where reference is made to “ppm” in the context of gases, this should be understood as ‘volume/volume’ (vol/vol).

The glass composition may contain alkali metal oxides, such as e.g. Li₂O, Na₂O, and K₂O, in amounts of less than 20% by weight, less than 15% by weight, less than 12% by weight, less than 10% by weight or less than 5% by weight. Optionally, the glass composition may be free of alkali metal oxides. In some embodiments, the amount of alkali metal oxides in the glass composition may be at least 1% by weight.

The glass composition may contain alkaline earth metal oxides, such as e.g. MgO, CaO, SrO, BaO, in amounts of less than 20% by weight, less than 15% by weight, less than 12% by weight, less than 10% by weight, or less than 5% by weight. Optionally, the glass composition may be free of alkaline earth metal oxides. In some embodiments, the amount of alkaline earth metal oxides in the glass composition may be at least 1% by weight.

The glass composition may contain SiO₂ in an amount of at least 48% by weight, at least 55% by weight, at least 65% by weight, at least 70% by weight or at least 75% by weight. Optionally, the amount of SiO₂ may range up to 90% by weight, up to 87.5% by weight, up to 85% by weight, up to 82.5% by weight, or up to 80% by weight.

Optionally, the glass composition may be that of a glass ceramic, i.e., a glass composition that can be further processed into a glass ceramic by appropriate heat treatment. In case that the glass composition is that of a glass ceramic, the composition may contain nucleating agents such as TiO₂ and/or ZrO₂. Optionally, the total amount of TiO₂ and/or ZrO₂ may be at least 2.0% by weight, such as at least 2.5% by weight. Optionally, the total amount of TiO₂ and/or ZrO₂ may be less than 7.0% by weight, or less than 5.0% by weight. The glass composition may, for example, be a lithium aluminosilicate glass composition, e.g., containing at least 2.0% by weight of Li₂O.

The glass composition may include one or more fining agents. The fining agent may be selected from multivalent metal oxides, halides, sulfates and combinations thereof. In some embodiments, the fining agent is selected from the list of arsenic oxide, antimony oxide, tin oxide, cerium oxide, chlorides, fluoride, sulfates and combinations thereof. The total amount of refining agents may be from 0.03-1.5% by weight.

In some embodiments, the glass composition comprises a fining agent selected from the list of arsenic oxide, antimony oxide, tin oxide or cerium oxide. The total amount of these refining agents may be from 0.03-1.5% by weight. According to some embodiments, the amount of each of As₂O₃ and/or, Sb₂O₃ and/or, SnO₂ and/or Ce₂O₃ in the glass composition is less than 1000 ppm, optionally less than 500 ppm and optionally less than 200 ppm. According to some embodiments, the glass composition is free of As₂O₃ and/or, Sb₂O₃ and/or, SnO₂ and/or Ce₂O₃.

In some embodiments, the glass composition comprises a fining agent selected from the list of chlorides, sulfates and combinations thereof. The total amount of refining agents may be from 0.03-1.5% by weight.

According to some embodiments, the glass composition is a halogenide refined glass composition and optionally, a chloride or fluoride refined glass composition and optionally a chloride refined glass composition. Such refining agents improve the electrical conductivity and reduce the specific resistance in the glass melt.

The glass composition might comprise coloring agents such as oxides of Co, Ni, Fe, Nd, Mo and other suitable coloring agents.

The glass composition may contain iron, calculated as Fe₂O₃, in an amount of less than 0.05% by weight, less than 0.01% by weight, or less than 0.005% by weight. In some embodiments, the glass composition may contain Fe₂O₃ in an amount of at least 0.0005% by weight, at least 0.001% by weight, or at least 0.002% by weight. In some embodiments, the glass composition may contain Fe₂O₃ in an amount of 0.0005% to 0.05% by weight, 0.001% to 0.01% by weight, or 0.002% to 0.005% by weight. The amount of Fe₂O₃ as indicated above relates to the total weight of the total iron in the glass composition, as if present in the form of the Fe₂O₃ oxide. This does not mean that all of the iron is present in this form. For example, any iron in the FeO form is included.

In some embodiments, the glass composition may contain Fe₂O₃ in an amount of less than 1000 ppm by weight, less than 500 ppm by weight, or less than 200 ppm by weight. Optionally, the glass composition may contain Fe₂O₃ in an amount of at least 1 ppm by weight, at least 10 ppm by weight, or at least 50 ppm by weight. In some embodiments, the glass composition may contain Fe₂O₃ in an amount of 1 to 1000 ppm, in an amount of 10 to 500 ppm, or in an amount of 50 to 200 ppm.

Optional glass compositions include Al₂O₃ in an amount of at least 1.0% by weight or at least 5.0% by weight or even at least 10.0% by weight. The amount of Al₂O₃ may be up to 25.0% by weight, up to 20.0% by weight or up to 18.0% by weight. In some embodiments, the amount of Al₂O₃ may range from 1.5% to 23.0% by weight, from 5.0% to 20.0% by weight or from 10.0% to 18.0% by weight.

Additionally, or alternatively, the glass composition may include B₂O₃ in an amount of at least 0.0% by weight or at least 8.0% by weight or even at least 10.0% by weight. The amount of B₂O₃ may be up to 25.0% by weight, up to 23.0% by weight, up to 20.0% by weight, up to 18.0% by weight, up to 16.0% by weight or up to 14.0% by weight. In some embodiments, the amount of B₂O₃ may range from 0.5% to 20.0% by weight, from 8.0% to 16.0% by weight, or from 10.0% to 14.0% by weight.

According to some embodiments, the glass composition might be free of heavy metals.

Many highly viscous glass compositions contain significant amounts of SiO₂, Al₂O₃ and B₂O₃. Optionally, the glass compositions used have a total content of SiO₂, Al₂O₃ and B₂O₃ of at least 75.0% by weight, at least 78.0% by weight or even at least 85.0% by weight. The total amount of SiO₂, Al₂O₃ and B₂O₃ may be limited to not more than 97.0% by weight, up to 93.5% by weight or up to 90.0% by weight. Optionally, the amount of SiO₂, Al₂O₃ and B₂O₃ may range from 75.0% to 95.0% by weight, from 78.0% to 92.5% by weight or from 85.0% to 90.0% by weight.

In some embodiments, the glass composition may be a lithium aluminosilicate glass comprising from 3.0 to 4.2% Li₂O by weight, from 19 to 23% Al₂O₃ by weight, from 60 to 69% SiO₂ by weight, optionally comprising TiO₂ and/or ZrO₂, optionally comprising from 2.0 to 4.0% TiO₂ and/or ZrO₂.

According to some embodiments, the glass tube has a glass composition comprising 60 to 85 wt.-% SiO₂, 5 to 20 wt.-% B₂O₃, 1 to 10 wt.-% Al₂O₃, 0 to 2 wt.-% Fe₂O₃, 2 to 10 wt.-% Na₂O, 0 to 5 wt.-% K₂O, 0 to 2 wt.-% BaO, 0 to 2 wt.-% CaO, 0 to 10 wt.-% TiO₂, based on all oxides present in the glass composition.

The inventors have found that, due to the reduced amount of gas bubbles on the contact surface of a glass tube, the yield of the glass tubes can be improved. Furthermore, by the apparatus and the method provided according to the present invention, it is possible to improve the quality of the generated glass tubes and, therefore, of the glass products obtained from the glass tubes, especially for the use in the pharmaceutical sector. Thus, according to some embodiments, the glass tube obtainable by the method provided according to the present invention can be used in various applications and sectors, such as the pharmaceutical sector.

According to some embodiments, the glass tube is used as an intermediate product for the production of pharmaceutical containers, optionally for the production of ampoules, vials, syringes and/or cartridges.

Exemplary embodiments provided according to the invention are shown in the figures and will be explained in more detail in the following description, wherein identical reference signs refer to identical or similar components or elements.

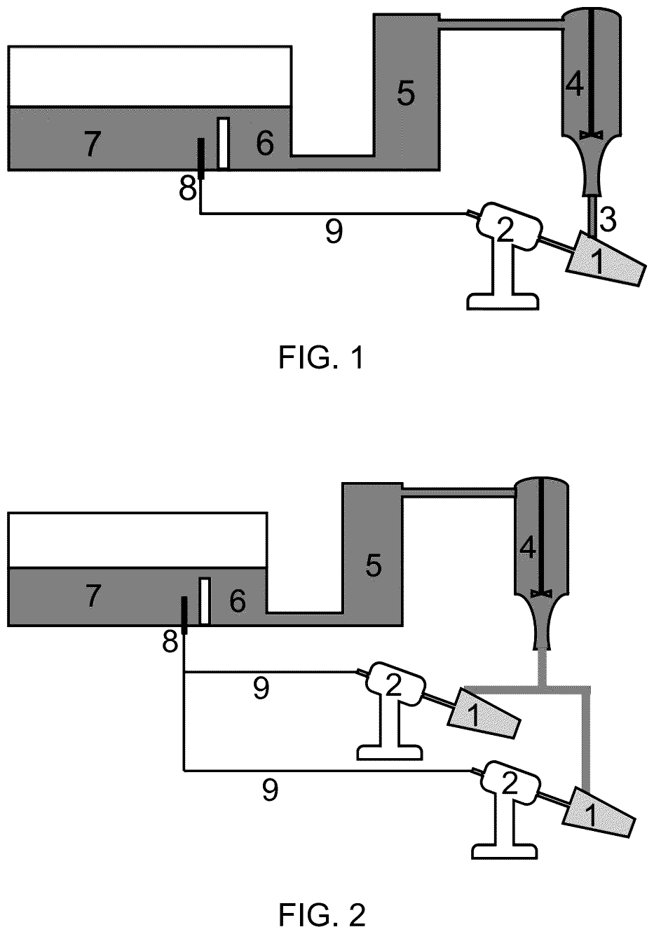

FIG. 1 shows a schematic of an embodiment of the glass tube forming apparatus. The glass tube forming apparatus comprises a tube forming body 1. The tube forming body 1 is in form of a Danner mandrel and consists of a ceramic material and is covered with a platinum alloy as metallic layer. The Danner mandrel is mounted on a holder 2. A strand of molten glass 3 flows on the tube forming body 2. The glass raw material is melted in the melting vessel 7 and afterwards flows into the fining vessel 6, a working tank 5 and a distributor 4. From the distributor a strand of molten glass 3 flows on the tube forming body 1. The glass is withdrawn from the tube forming body 1 in form of a glass tube. A molybdenum electrode 8 is present in the melting vessel 7 and is in direct contact with the glass melt. The electrode is connected electrical with wires 9 with the metallic layer on the glass tube forming body 1.

Due to the different metals on the tube forming body and of the metallic electrode a potential drop is generated, such that a direct current flows from the tube forming body 1 to the at least one molybdenum electrode 8.

FIG. 2 shows a further schematic of an embodiment of the glass tube forming apparatus. The difference to FIG. 1 is that the glass tube forming apparatus comprises two tube forming bodies 1, which are in form of a Danner mandrel and consist of a ceramic material and are covered with a platinum alloy as metallic layer. The strand of molten glass 3 flows from the distributor 4, is afterwards divided into several strands, which flow on the several tube forming bodies 1. A molybdenum electrode 8 is present in the melting vessel 7 and is in direct contact with the glass melt. The electrode is connected electrical with wires 9 with the metallic layer on the two glass tube forming bodies 1.

Due to the different metals on the tube forming bodies and of the metallic electrode, a potential drop is generated, such that a direct current flows from the two tube forming bodies 1 to the at least one molybdenum electrode 8.

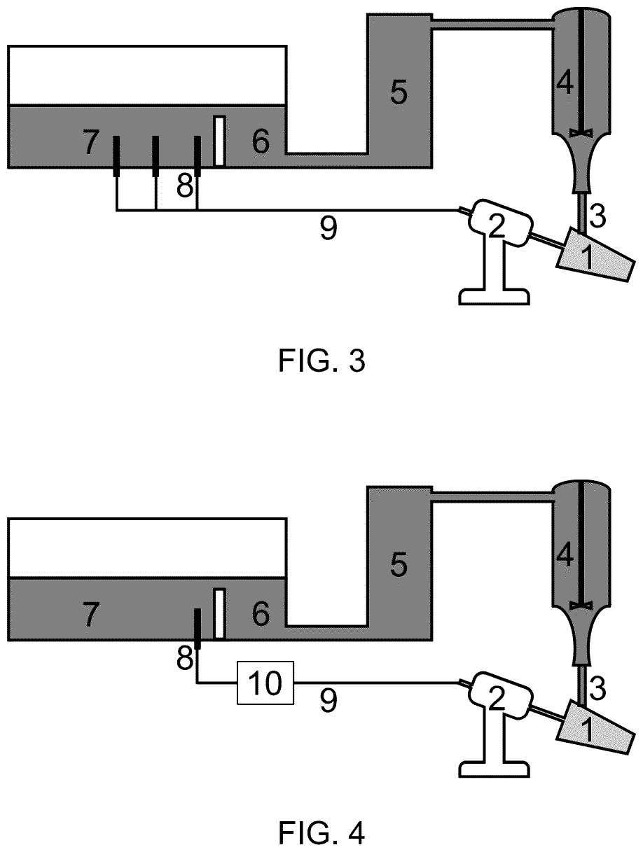

FIG. 3 shows a further schematic of an embodiment of the glass tube forming apparatus. The difference to FIG. 1 is that the glass tube forming apparatus comprises several molybdenum electrodes 8 which are present in the melting vessel 7 and are in direct contact with the glass melt. The electrodes are connected electrically with wires 9 with the metallic layer on the glass tube forming body 1.

Due to the different metals on the tube forming body and of the metallic electrode, a potential drop is generated, such that a direct current flows from the tube forming body 1 to the at least one molybdenum electrode 8.

FIG. 4 shows a further schematic of an embodiment of the glass tube forming apparatus. The difference to FIG. 1 is that an electric circuit 10 comprising electronic components is located in series in the electrical connection between the tube forming body and the at least one electrode.

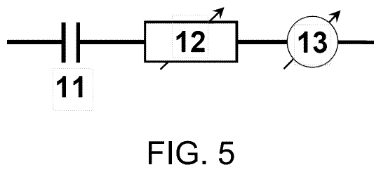

FIG. 5 shows a schematic of the electric circuit. In the electric circuit a DC current source, an electronic voltage filter in form of a resistor and an electronic voltage control in form of a rotary potentiometer are arranged in series between the at least one metallic electrode and the tube forming body.

### Methods and Examples

### Manufacturing of Glass Tubes

A borosilicate glass composition as set out below has been used to manufacture two different glass tubes (Glass tubes I and glass tubes II) wherein the manufacturing process is based on a Danner process. The temperature in the melting vessel was about 1600 to about 1650° C. The average time of the glass melt in the melting vessel was about 40 to 60 hours. Glass tubes with an inner diameter dᵢ from 6 mm to 40 mm, and a length lₐ from 1500 to 1800 mm have been produced. Glass tubes I have been manufactured according to the prior art process and glass tubes II have been manufactured according to the method provided according to the present invention. The manufacturing parameters like temperatures, time, withdrawing speed have been kept constant in these two examples. Furthermore, the equipment such as for example the melting or fining vessel, the electrodes or the glass tube forming body were identical.

### Borosilicate Glass:

75 wt.-% SiO₂, 10.5 wt.-% B₂O₃, 5 wt.-% Al₂O₃, 7 wt.-% Na₂O, 1.5 wt.-% CaO

As a difference between Example 1 and Example II, the tube forming body has been connected electrical with the electrodes in the melting vessel as shown in FIG. 2. By this electric circuit a potential drop between the tube forming body and the at least one electrode was generated that caused a direct current. By this direct current, the voltage that has been measured directly at the tube forming body was reduced by 258.0 mV. By this electric circuit, the oxygen partial pressure on the glass melt at the point of the tube forming body has been significantly reduced resulting in a reduced amount of gas bubbles in the glass melt at the tube forming body.

The obtained glass tubes I and II have been analyzed in view of the aggregated air line length on the contact surface of the glass tubes as can be seen in the table below. The below results have been measured for a lengths of 10 m.

| | Aggregated Air line | Aggregated Air line |
|---|---|---|
| | length per 10 m at tube | length per 10 m at tube |
| | forming body 1 | forming body 2 |
| Example I | 123 cm | 350 cm |
| Example II | 2 cm | 4 cm |

From the above examples it can be seen that by the method and the tube forming apparatus provided according to the present invention, it is possible to reduce the amount of gas bubbles on the contact surface of a glass tube and to provide a glass tube having an aggregated air line length of less than 0.10 m per 1.0 m tube length on the contact surface of the glass tube, wherein the aggregated air line length is defined as the sum of the lengths of closed air lines having a length>15 mm and open air lines having a length>2 mm. Especially it has been shown that by the method and the tube forming apparatus provided according to the present invention, a glass tube having an aggregated air line length of about 0.002 m per 1.0 m tube length and 0.004 m per 1.0 m tube length on the contact surface of the glass tube has been provided.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 glass tube forming body covered at least partly with a metallic layer
2 holder of the glass tube forming body
3 strand of molten glass
4 distributor
5 working tank
6 fining vessel
7 melting vessel
8 metallic electrode
9 electrical connection between the tube forming body and the at least one electrode
10 electric circuit comprising electronic components
11 external DC current source
12 electronic voltage filter in form of a resistor
13 electronic voltage control in form of a rotary potentiometer

What is claimed is:

1. A glass tube forming apparatus, comprising:
a tube forming body configured to receive a flow of molten glass from a glass melt, wherein the molten glass is withdrawn from the tube forming body in the form of a glass tube, wherein the tube forming body is covered at least partly with a metallic layer; and
at least one metallic electrode mounted in the glass melt in spaced relation to the tube forming body, wherein the tube forming body is connected electrically with the at least one electrode.

2. The glass tube forming apparatus of claim 1, wherein a metal of the metallic layer on the tube forming body and/or the at least one metallic electrode is selected from the group consisting of molybdenum, tungsten, tantalum, tin oxide, platinum, rhodium, iridium, and alloys thereof, high melting refractory metals, oxides thereof and alloys thereof, oxide dispersion-strengthened metal compounds and alloys thereof, and heat-resistant steel.

3. The glass tube forming apparatus of claim 2, wherein the metal of the metallic layer on the tube forming body and the at least one metallic electrode are different metals.

4. The glass tube forming apparatus of claim 1, wherein the at least one metallic electrode is mounted in a melting vessel and/or a fining vessel and/or a working tank and/or a distributor.

5. The glass tube forming apparatus of claim 1, further comprising an electronic voltage filter that is located in series in the electrical connection between the tube forming body and the at least one electrode.

6. The glass tube forming apparatus of claim 1, further comprising an electronic voltage adjustment or an electronic voltage control that is located in series in the electrical connection between the tube forming body and the at least one electrode.

7. The glass tube forming apparatus of claim 1, further comprising an external direct current source that is located in series in the electrical connection between the tube forming body and the at least one electrode.

8. The glass tube forming apparatus of claim 1, wherein the tube forming body is a Danner mandrel or is a needle and an outlet nozzle.

9. A method for reducing an amount of gas bubbles on a contact surface of a glass tube, the method comprising:
providing a tube forming body configured to receive a flow of molten glass from a glass melt, wherein the tube forming body is covered at least partly with a metallic layer;
providing at least one metallic electrode mounted in the glass melt in spaced relation to the tube forming body;
providing an electrical connection between the tube forming body and the at least one electrode;
generating a potential drop between the tube forming body and the at least one electrode to cause a direct current; and
withdrawing the molten glass from the tube forming body in the form of a glass tube as the direct current flows between the tube forming body and the at least one electrode.

10. The method of claim 9, wherein the potential drop is generated at least partly by a difference of a metal of the metallic layer on the tube forming body and a metal of the at least one metallic electrode, wherein the metal of the metallic layer and the metal of the at least one metallic electrode are selected from the group consisting of molybdenum, tungsten, tantalum, tin oxide, platinum, rhodium, iridium and alloys thereof, high melting refractory metals, oxides thereof and alloys thereof, oxide dispersion-strengthened metal compounds and alloys thereof, and heat-resistant steel.

11. The method of claim 9, wherein the direct current flows from the tube forming body to the at least one metallic electrode.

12. The method of claim 11, wherein a direct current density on the tube forming body is in a range from 0.05 mA/cm² to 5.0 mA/cm².

13. A glass tube having an aggregated air line length of less than 0.10 m per 1.0 m tube length on a contact surface of the glass tube, wherein the aggregated air line length is defined as a sum of lengths of closed air lines having a length>15 mm and open air lines having a length>2 mm.

14. The glass tube of claim 13, having an aggregated air line length of less than 0.050 m per 1.0 m tube length on a surface of an inside of the glass tube.

15. The glass tube of claim 13, wherein the glass tube has a glass composition comprising 60 to 85 wt.-% SiO₂, 5 to 20 wt.-% B₂O₃, 1 to 10 wt.-% Al₂O₃, 0 to 2 wt.-% Fe₂O₃, 2 to 10 wt.-% Na₂O, 0 to 5 wt.-% K₂O, 0 to 2 wt.-% BaO, 0 to 2 wt.-% CaO, 0 to 10 wt.-% TiO₂, based on all oxides present in the glass composition.

16. The glass tube of claim 13, wherein the glass tube has at least one of the following:
an outer diameter dₒ from 5 mm to 55 mm;
a wall thickness WT from 0.4 mm to 2.5 mm;
an inner diameter dᵢ from 4 to 51 mm; or
a length lₐ from 500 to 3500 mm.
